(19) United States
(12) Patent Application Publication
(10) Pub. No.: US 2025/0035087 A1
(43) Pub. Date: Jan. 30, 2025

(54) A NACELLE INSTALLATION METHOD AT A WIND TURBINE

(71) Applicant: Vestas Wind Systems A/S, Aarhus N. (DK)

(72) Inventors: Jakob Anders Sørensen, Fredericia (DK); Torben Ladegaard Baun, Skødstrup (DK)

(21) Appl. No.: 18/710,890

(22) PCT Filed: Oct. 31, 2022
(86) PCT No.: PCT/DK2022/050226

§ 371 Date: May 16, 2024

(30) Foreign Application Priority Data
Nov. 23, 2021 (DK) PA202170582

(51) Int. Cl. F03D 13/10; F03D 13/20; F03D 80/80

(52) U.S. Cl. CPC F03D 13/116; F03D 13/139; F03D 13/20; F03D 80/82; F05B 2240/916

(57) ABSTRACT

Wind turbine installation method the installation method including: providing a nacelle (2) at a wind turbine erection site, said nacelle (2) comprising: a main unit (20), arranged to be connected to the wind turbine tower (3), and configured for housing a rotor-supporting assembly of the wind-turbine: at least one auxiliary unit (21, 22) housing an operative component (34) forming part of the power conversion assembly, wherein: the main unit (20) and the auxiliary unit (21, 22) are separate units configured to be connected by a unit fixation structure at an interface, and wherein the operative component (34) is supportable directly on the main unit (20), said method further including: receiving a said main unit (20) and an auxiliary unit (21, 22) and an operative component (34) to said site of erection of the wind turbine, attaching to said main unit (20) the said auxiliary unit (21, 22) and said operative component (34). and attaching a lifting yoke (50) to the main unit (20) and hoisting the main unit (20) together with the auxiliary unit (21, 22) by means of a crane attached to the lifting yoke (50), wherein the auxiliary unit (21, 22) is supported and lifted by the main unit (20) during the hoisting, and installing the main unit (20) and the attached auxiliary unit (21, 22) at the tower top.

The present disclosure relates to a nacelle installation method at a wind turbine. The nacelle of the present disclosure is particularly suitable for use in large wind turbines. The disclosure further relates to a method for assembling, lifting and installing a wind turbine comprising such a nacelle.

### BACKGROUND

Wind turbines increase in size in terms of nominal power output as well as in terms of physical dimensions of the individual parts of the wind turbine. Therefore, the size of the nacelle must also be increased to accommodate the required wind turbine components. Wind turbines are normally transported from the location or locations of manufacture of the individual parts to the operating site where the wind turbine is erected by road, rail or ship or a combination thereof. In WO2021/098927A1, it is proposed to provide a nacelle in the form of a main unit and at least one auxiliary unit mountable on a side of the main unit. Such a nacelle can be transportable using ordinary transport means and may thus lower transportation and handling costs without limiting the possible size of the nacelle.

### SUMMARY

It is an object of embodiments of the disclosure to facilitate aspects of installation of a wind turbines nacelle.

According to these and other objects, the disclosure provides a method for installing a wind turbine nacelle configured for mounting on a wind turbine tower. More particularly, the disclosure provides a method for lifting a wind turbine nacelle to a tower top location of the wind turbine.

The installation method includes:
providing a nacelle at a wind turbine erection site, said nacelle comprising:
a main unit, arranged to be connected to the wind turbine tower, e.g. via a yawing arrangement, and configured for housing a rotor-supporting assembly of the wind-turbine;
at least one auxiliary unit housing an operative component forming part of the power conversion assembly, wherein:
the main unit and the auxiliary unit are separate units configured to be connected by a unit fixation structure at an interface, and wherein the operative component is supportable directly on the main unit, said method further including:
receiving a said main unit to a site of erection of the wind turbine,
receiving a said auxiliary unit to said site of erection of the wind turbine,
receiving a said operative component to said site of erection of the wind turbine,
attaching to said main unit the said auxiliary unit and said operative component, and
attaching a lifting yoke to the main unit and hoisting the main unit together with the auxiliary unit by means of a crane attached to the lifting yoke, wherein the auxiliary unit is supported and lifted by the main unit during the hoisting, and
installing the main unit and the attached auxiliary unit at the tower top, and
releasing the lifting yoke from the main unit. The main unit and the auxiliary unit are separate units assembled via an interface by a unit fixation structure, and the operative component is supported directly on the main unit or on an element thereof such as a base frame of the main unit.

Since the auxiliary unit accommodates an operative component supported directly on the main unit, and since the main unit is connectable to the wind turbine tower, the main unit, or an element thereof such as a base frame, forms a load path for the operative component into the wind turbine tower. A method according to the invention is defined in appended claim 1. Further optional features thereof are defined in subclaims 2-14.

If needed, the auxiliary unit may be released from the main unit without releasing the operative component, and the auxiliary unit may be designed for smaller loads compared to the main unit. It may e.g. be dimensioned and designed for storage and transportation of the operative component but not for carrying the full load of the operative component when assembled atop the tower.

Examples of a main unit and/or an auxiliary unit include units of any size and shape and configured to be assembled.

The auxiliary and/or the main unit may be formed with size and/or the outer shape comparable to, or equal to, the size and shape of a shipping freight container. Each unit thereby inherits the advantages of shipping freight containers with respect to handling, transportation, and storage. Shipping freight containers can for example be handled anywhere in the world by ship, train, and truck etc. and at lower costs compared to bulk transport.

The cost savings are even more pronounced when the main and/or auxiliary unit is a shipping freight container. A shipping freight container is also referred to as an intermodal container, a standard freight container, a box container, a sea fright container, or an ISO container, and refers in general to a container used to store and move materials and products in the global containerized intermodal freight transport system for intercontinental traffic. The shipping freight container may follow the dimensional and structural specifications in the ISO standard of ISO 668:2013 for series 1 freight containers. An auxiliary unit may optionally comprise a so-called “high-cube” version of a standard shipping container.

The main unit and the auxiliary unit may be arranged side by side in a direction away from a rotational axis defined by the rotor-supporting assembly as opposed to one after the other in the direction of the rotational axis.

In one embodiment, the nacelle may comprise two auxiliary units, e.g. arranged on opposite sides of the main unit.

The nacelle may be carried either directly by the tower or indirectly by the tower via an intermediate tower structure. If the wind turbine is of the traditional horizontal axis type, the nacelle is typically carried by a yawing arrangement between the tower top and the nacelle. The disclosure may, however, also relate to a multiple rotor wind turbine of the kind where more than one nacelle are carried by a transverse beam structure which is again carried by the tower, e.g. via a yawing arrangement between the tower and the transverse beam structure.

The disclosure may relate to an upwind wind turbine or to a downwind wind turbine.

The nacelle comprises a main unit and at least one auxiliary unit. The main unit is the part connecting the nacelle to the tower, either directly or indirectly via said intermediate tower structure or structures. The main unit may particularly be the central part of the nacelle and houses parts of the drivetrain such as at least a part of the rotor shaft.

The wind turbine could be a direct drive wind turbine with the generator typically placed outside the nacelle, or the wind turbine could be with the generator located in the main unit. The main unit supports the rotor via the rotor shaft.

The main unit may, depending on the type of wind turbine, comprise further parts, e.g. a gear box, a bearing system and different kinds of peripheral equipment, e.g. for lubrication, cooling, and control purpose. The main unit may particularly comprise a main frame forming part of the rotor-supporting assembly and forming a load path from the rotor into the tower or intermediate tower structure, e.g. via a yawing arrangement. The main frame may particularly be a casted component.

In addition to the main frame, the rotor-supporting assembly may comprise e.g. a bearing structure and other components supporting the rotor in the wind turbine.

The operative component which is housed in the auxiliary unit may particularly be supported directly on the main frame, i.e. such that the main frame forms a load path from the operative component into the tower. This may in particular be a cantilever support arrangement of the operative unit. Particularly, the operative component may be supported on the main frame via a first supporting structure and may be supported such that the auxiliary unit does not form part of the load path from the operative component into the tower. In particular, the operative component may be supported by the main frame in a cantilever arrangement of the operative component at the main frame. In particular, the first supporting structure may be a cantilever type supporting structure.

The nacelle may be rotatable relative to the tower via a yawing arrangement. This may either be facilitated by connecting the nacelle to the tower via the yawing arrangement, or, in a multi rotor wind turbine, by connecting at least two main frames of individual nacelle structures to a tower via said intermediate tower structure which is again joined to the tower via a yawing arrangement.

The nacelle may comprise a second supporting structure configured for supporting the operative component on the auxiliary unit.

The unit fixation structure may be configured to fixate the auxiliary unit to the main unit in an assembly position of the auxiliary unit relative to the main unit. The unit fixation structure may be configured to fixate the auxiliary unit to the main unit in a cantilever arrangement of the auxiliary unit at the main unit. The first supporting structure may be configured to take over support of the operative component from the second supporting structure upon movement of the auxiliary unit to the assembly position.

In one example, the operative component is carried, e.g. on the floor or on a wall, of the auxiliary unit by the second supporting structure, and when the auxiliary unit is lowered into the assembly position, the first supporting structure lifts the operative component out of the supporting relationship with the auxiliary unit. From that moment, the operative component is supported on the main frame via the second supporting structure, and preferably lifted free from the floor of the auxiliary unit.

In another example, the operative component is carried, e.g. on the floor or on a wall, of the auxiliary unit by the second supporting structure, and when the auxiliary unit is in the assembly position, the first supporting structure is attached between the operative component and the main frame. At that point in time, the first supporting structure and the second supporting structure both support the operative component. The second supporting structure may, in some embodiments, be removed such that the supporting is exclusively by the first supporting structure directly on the main frame.

The first supporting structure may comprise at least one bracket connected to the operative component and to the main frame, and each bracket may extend through a corresponding wall opening in an outer wall of at least one of the main unit and the auxiliary unit.

Each wall opening may have a size exceeding a cross-sectional dimension of the corresponding bracket to define a gap between an edge about the wall opening and the bracket. This allows the load on the brackets to be carried by the main frame without influencing the outer wall of the main unit or auxiliary unit.

The gap between the wall opening and the brackets may be sealed by a sealing structure, e.g. a rubber gasket extending between an edge of the wall and the bracket.

The first supporting structure may, in one embodiment, constitute or form part of the unit fixation structure. In this embodiment, the first supporting structure holds the auxiliary unit in place on the main unit.

The power conversion assembly converts the power from the generator into a desired energy form. The power conversion assembly may be configured for delivering electrical power, e.g. in AC or DC.

In case of electrical energy, the power conversion assembly may be configured for linking the generator e.g. to an external power grid. In that case, the power conversion assembly may be constituted e.g. by a converter, and/or a transformer, and/or a switch gear. Any such components may be comprised in the power conversion assembly.

The operative component may therefore be constituted by a converter and/or a transformer, and/or a switch gear etc. Such components can suitably be housed in an auxiliary unit, and advantageously be carried directly by the main unit since they are relatively heavy components. The load path from such components to the tower may therefore be as short as possible, and it is therefore an advantage to support such components directly on the main unit and thereby carry at least a part of the weight of these components directly by the main unit which is connected to the tower.

Additionally, the mentioned components are often supplied to the site where the wind turbine is erected by an external supplier not being involved with the drivetrain and other parts of the wind turbine. Accordingly, the encapsulation in a separate unit away from the drivetrain may be an advantage and reduce the risk of unintended access for unauthorised personnel.

Further, the converter and the transformer are high voltage components which, for safety reasons, may be separated from the main unit.

Additionally, these mentioned components are expensive and complex components for which service or replacement may suitably be carried out by specially trained staff, e.g. by lowering the operative components to the ground when housed in the auxiliary unit, or at least by working in a working area which is isolated from the rotating and potentially dangerous drivetrain.

The generator may, as an example, be an asynchronous or synchronous generator, e.g. an asynchronous or synchronous generator, and the converter voltage may be in same range as a generator voltage, sometimes referred to as Stator voltage.

The generator, in another example, may be a doubly fed induction generator (DFIG). In that case, the voltage on the converter could be different from the Generator stator voltage. The converter is connected to generator rotor, and is normally the same voltage or a voltage which is lower than the stator voltage.

Low voltage may e.g. be considered as voltages up to 1000V. Medium voltage may be considered as voltages of 1 KV to about 60 kV. The generator Voltage could be low voltage, or medium voltage.

The main unit and the auxiliary unit are assembled at the interface by a unit fixation structure. The unit fixation structure may fixate the auxiliary unit to the main unit when the auxiliary unit is an assembly position, and it may be suitable for allowing release of the auxiliary unit from the main unit at a later date after the main unit is assembled on the tower top for example for service or replacement. For that purpose, the unit fixation structure may comprise mutually interlocking structural features on the main unit and on the auxiliary unit. Examples of such mutually interlocking features may be protrusions on one of the main and auxiliary unit and indentations or holes on the other one of the main and auxiliary unit, the unit fixation structure may form a bolted interface allowing releasable joining of the main and auxiliary units, or the auxiliary unit may be held in place on the main unit by cables by which the auxiliary unit can be lowered to the ground for service, replacement of components, or for transport of components and personnel between ground and the nacelle. In one embodiment, the unit fixation structure is configured such that the auxiliary unit can be received by the main unit when the auxiliary unit is lowered in close vicinity to the main unit. Such a unit fixation structure may be constituted by hooks or by interlocking structures on the main unit and the auxiliary unit. This may particularly be combined with a first supporting structure configured to receive the load of the operative component upon the movement of the auxiliary unit to the position where the unit fixation structure fixates the auxiliary unit on the main unit.

The operative component is accommodated in the auxiliary unit but supported directly on the main unit, e.g. directly on the main frame in the main unit. Herein that means that at least a part of the load of the operative component is transferred directly to the main unit without loading the auxiliary unit or the unit fixation structure. This load is herein referred to as the direct load.

The direct load does not necessarily constitute the entire load caused by the operative component accommodated in the auxiliary unit but is a major part thereof. Thus, the direct loads may e.g. constitute anything e.g. from 50 percent to 100 percent of the total load caused by the operative component accommodated in the auxiliary unit and supported directly on the main unit. Particularly, the direct load may constitute 100 percent of the total load meaning that the operative component is entirely carried by the main unit. The weight of the operative component in a 5 MW wind turbine may as an example be 25-30 ton (transformer and/or converter), and the weight of an auxiliary unit for housing such a component may be 5-15 tons. Accordingly, to pass the load of the operative component at least partly to the main unit and particularly to the main frame may be an advantage.

The direct load is neither transferred to the auxiliary unit, nor transferred to the main unit via the auxiliary unit-rather, it is transferred directly to the main unit e.g. directly to the main frame.

The main unit and the auxiliary unit may be arranged side by side in a direction away from the rotational axis. This means that the auxiliary unit is shifted sideways away from the rotational axis relative to the main unit. The auxiliary unit may e.g. be in a direction perpendicular to a rotational axis of the wind turbine rotor. This provides for an advantageous modularity of the nacelle with the advantageous distribution of the main wind turbine components such as to have both the main bearing system and the drivetrain system assembled in the main unit and other components in the auxiliary unit sideways shifted away from the drivetrain. Accordingly, the interface between the main unit and the auxiliary unit may particularly extend in the direction of the rotational axis.

In one embodiment, several operative components are housed in the auxiliary unit and supported directly on the main unit. The operative component may be a transformer and a converter which is thereby housed in the same auxiliary unit.

The first supporting structure may be configured for releasable support of the operative component and thereby facilitate the supporting of the operative component directly on the main unit. The first supporting structure may be particularly suitable for allowing release of the operative component from the main unit. For that purpose, the first supporting structure may comprise mutually interlocking structural features on the main unit and on the operative component. Examples of such mutually interlocking features may be protrusions on one of the main unit and the operative component and indentations or holes on the other one of the main unit and the operative component, the first supporting structure supporting structure may include a bolt interface allowing releasable joining of the operative component to the main unit, or the operative component may be held in place on the main unit by cables by which the operative component can be lowered to the ground for service or replacement. The first supporting structure may also constitute the interface which holds the auxiliary unit on the main unit. I.e. the auxiliary unit may be held in place on the main unit via the first supporting structure.

The second supporting structure may be configured for releasable suspension of the operative component on the auxiliary unit. In one embodiment, the second supporting structure is a support structure configured for the operative component to stand on a floor of the auxiliary unit. Such a support structure may include e.g. legs, beams, or similar structures arranged between the floor of the auxiliary unit and the operative component.

The second supporting structure may be particularly suitable for allowing release of the operative component from the auxiliary unit. For that purpose, the second supporting structure may comprise mutually interlocking structural features on the auxiliary unit and on the operative component. Examples of such mutually interlocking features may be protrusions on one of the auxiliary unit and the operative component and indentations or holes on the other one of the auxiliary unit and the operative component. The second supporting structure may include a bolt interface allowing releasable joining of the operative component to the auxiliary unit, or the operative component may be held in place in the auxiliary unit by cables by which the operative component can be lowered to the ground for service or replacement. The second supporting structure may particularly allow the auxiliary unit to carry the operative component during transportation via the second supporting structure.

As mentioned previously, the first and second supporting structure may be configured such that load is transferred from the second supporting structure to the first supporting structure when the auxiliary unit is attached to the main unit, i.e. when it is moved towards the assembly position. Alternatively, or additionally, the first supporting structure and the second supporting structure may be configured for simultaneous suspension of the operative component both to the main unit and to the auxiliary unit to thereby allow the operative component to be carried both by the main unit and by the auxiliary unit, e.g. such that a larger percentage of the load is carried by the main frame in the main unit, and a small percentage, below 50 percent, or below 10 percent is carried by the auxiliary unit. Further, the first supporting structure and the second supporting structure may be configured for automatic switching between the carrying of the operative component by the main unit to the carrying of the operative component by the auxiliary unit, vice versa.

The assembly procedure includes:
joining, at the ground, the main unit and the auxiliary unit via the unit fixation structure. Subsequently, they are hoisted and attached to the tower as one assembled nacelle.

The auxiliary unit may be used as a guide for correct positioning of the operative component relative to the main unit, i.e. when the auxiliary unit is attached via the unit fixation structure, the operative component is correctly positioned for attachment to the main unit via the first supporting structure. Subsequently, the operative component can be released from the auxiliary unit via the second supporting structure whereby the auxiliary unit functions only as a shield for weather protection and/or to form an indoor working platform for maintenance of the operative component. The operative component may e.g. be released from the auxiliary unit to establish a load path from the operative component directly into the main frame in the main unit.

The auxiliary unit may be attached directly to the main unit via the interface. The interface may provide a sealed connection preventing intrusion of air, water, and dirt into the main unit. The auxiliary unit may also be carried by an adapter inserted between the yaw arrangement and the main unit.

At least two auxiliary units may be included in the nacelle. Two auxiliary units could be arranged on opposite sides of the main unit. In that embodiment, the two auxiliary units may be on opposite sides of a vertical plane in which the rotational axis extends. For hoisting the nacelle, the main unit may be hoisted from the ground carrying an auxiliary unit and a second auxiliary unit may be hoisted separately to the nacelle once the main unit and a first auxiliary unit are installed at a tower top. Alternatively, a nacelle including a main unit carrying two auxiliary units may be assembled at the ground and lifted to a tower top all together in one lift.

Two auxiliary units could be arranged above each other on one side of the main unit or on both sides of the main unit. In that case, the two auxiliary units may e.g. be on opposite sides of a horizontal plane, e.g. in which the rotational axis extends. Such a plane would be determined by the rotational axis and a point horizontally adjacent the rotational axis.

Two auxiliary units could be arranged one after the other to form a row of auxiliary units and therefore separated by a vertical plane extending perpendicular to the rotational axis.

If two auxiliary units are arranged above each other or one after the other, the nacelle may comprise a third fixation structure for releasable fixation of one of the auxiliary units on the other one of the auxiliary units. In that way, one of the auxiliary units may form a load path for the other auxiliary units into the main unit and thereby to the wind turbine tower.

The third fixation structure may allow release of one of the auxiliary units from the other one of the auxiliary units. For that purpose, the third fixation structure may comprise mutually interlocking structural features on the two auxiliary units, e.g. in the form of protrusions on one unit and indentations or holes on the other one of the units.

The third fixation structure may include a bolt interface allowing releasable joining of the auxiliary units to each other.

If the two auxiliary units are arranged one above the other, the lower one of the auxiliary units may be held in place on the upper one of the auxiliary units by cables by which the lower one of the auxiliary units can be lowered to the ground for service or replacement.

Two auxiliary units may be arranged above each other or one after the other on one side of the main unit and two auxiliary units may be arranged above each other or one after the other on an opposite side of the main unit.

The operative component may comprise an electrical connector configured for electrical connection with the generator. The electrical connector may be connected via the interface between the main unit and the auxiliary unit. Particularly, this interface may be operated from the main space in the main unit and thereby allow connection or interruption of the connection without entering the auxiliary unit. Alternatively, this interface may be operated from an auxiliary space in the auxiliary unit and thereby allow connection or interruption of the connection without entering the main unit.

The main unit may particularly be configured for isolation of the rotor-supporting assembly physically separated from the operative component. The isolation may e.g. be hermetic, i.e. air-tight, isolation, or fire or waterproof isolation preventing spreading of fire or water.

The auxiliary unit may also be configured for isolation of the transformer and converter from the rotor-supporting assembly. Again, this may be hermetic isolation, or fire proof isolation, or water proof isolation.

In one embodiment, the main unit and the auxiliary units are joined in an interface forming a gap allowing air to pass e.g. from beneath the nacelle to above the nacelle, through the gap. Such a gap may increase thermal convection and thus cooling of the space inside the main and auxiliary units.

The first supporting structure may extend across the gap through openings in walls of both the main and the auxiliary unit, and space between the openings and the first supporting structure could be sealed by a gasket, e.g. of resilient rubber or other flexible material ensuring that the load of the operative component is not transferred to the walls of the main or auxiliary unit.

A gasket may also be arranged where access ways, e.g. doors or passages for cables or bus-bars, extend across the gap. The gasket may be designed to withstand a pressure which exceeds a blowout pressure on which other pressure release structures act, e.g. said blowout panels etc.

In one embodiment, vibration dampening material is arranged between the main unit and the auxiliary unit. Rubber or foam material, or material with a similar elastically deformable and vibration dampening effect may be used. The dampening material may particularly be compressed between the main unit and the auxiliary unit and it may particularly be arranged where the main unit and the auxiliary unit are fixed by nails, rivets, bolts or any similar mechanical attachment.

In one embodiment, the main unit is broader than the auxiliary unit(s). That the main unit is “broader” means that its dimension in a horizontal plane, and perpendicular to the rotational axis is larger than the same dimension of the auxiliary unit(s). The main unit may particularly be broader than a shipping freight container following the dimensional and structural specifications in the ISO standard of ISO 668:2013 for series 1 freight containers, whereas the auxiliary unit(s) may have the size of, or be smaller than what is specified for those ISO standard, ISO 668:2013, series 1 freight containers.

The nacelle may comprise a hoist structure attached to the main unit and configured to hoist the auxiliary unit in a vertical direction from ground to a position where the unit fixation structure can connect the auxiliary unit to the main unit. This means that the hoist structure is configured to hoist the auxiliary unit vertically without having to move it in other directions. This hoisting procedure is particularly suitable in combination with the unit fixation structures comprising rotatable or slidable hooks facilitating attachment without necessitating relative movement between the main and auxiliary units in other directions than vertical.

The hoist structure may e.g. include a cantilever beam structure movable between a suspended and a retracted configuration. In the suspended configuration, the cantilever beam structure forms at least one and optionally several outwards projecting cantilevers configured to carry an auxiliary unit and usable for hoisting an auxiliary unit towards and away from the main unit. The outwards projecting cantilever beam structure may particularly be attached on a roof part of the main unit.

In one embodiment, the power conversion assembly is configured for converting electrical power from the generator into chemically stored forms of energy, e.g. into hydrogen, ammonia, or methanol. The operative component may therefore be constituted by an electrolysis cell stack, or a battery etc. Such components can suitably be housed in an auxiliary unit, and advantageously be carried directly by the main unit since they are relatively heavy components.

In a second aspect, the disclosure provides a method of assembling a wind turbine. According to this method, the main unit may be transported to a place where the wind turbine is erected. The auxiliary unit may e.g. be prepared by a supplier of the operative component and received to the site of erection of the wind turbine including the operative component, and the operative component is attached to the main unit while it is contained in the auxiliary unit.

Particularly, the method may comprise attaching the operative component directly to a main frame which forms part of a load path from the rotor to the wind turbine tower.

During an initial phase of the assembly, the operative component could be carried by the auxiliary unit. During the assembly of the auxiliary unit with the main unit, the operative component, while carried in the auxiliary unit is lifted to the position where the auxiliary unit can be attached to the main unit. Herein, that position is called “the assembly position”. When reaching the assembly position, the load of the operative component is moved from the auxiliary unit to the main unit, and particularly to the main frame in the main unit.

In one embodiment, load is transferred from the second supporting structure to the first supporting structure while moving the auxiliary unit towards the assembly position wherein the unit fixation structure connects the auxiliary unit to the main unit.

In a third aspect, the disclosure provides a method of servicing a wind turbine according to the first aspect. According to this method, the operative component is detached from the main unit while it is contained in the auxiliary unit and lowered to the ground in the auxiliary unit for service or replacement at ground.

The main unit and the auxiliary unit may be categorised as two different safety categories with different regulations relative to fire, toxic escape, temperature, or electricity.

Tthe disclosure provides a wind turbine nacelle configured for mounting on a wind turbine tower, the nacelle comprising:
a main unit arranged to be connected to the wind turbine tower and housing the rotor-supporting assembly, and
at least one auxiliary unit.

In this aspect, the main unit and the auxiliary unit are separate units configured to be connected by a unit fixation structure at an interface, and the main unit comprises a crane structure attached to the main unit and configured to hoist the auxiliary unit in a vertical direction from ground to a position where the unit fixation structure can connect the auxiliary unit to the main unit. Particularly, the unit fixation structure may comprise a movable support structure, e.g. in the form of the pivotable or slidable hook disclosed herein.

### LIST OF NUMBERED EMBODIMENTS

1. A wind turbine nacelle (2) configured for mounting on a wind turbine tower (3) and housing a rotor-supporting assembly, a generator (33), and a power conversion assembly, the nacelle comprising:
a main unit (20) arranged to be connected to the wind turbine tower (3) and housing the rotor-supporting assembly, and
at least one auxiliary unit (21, 22) housing an operative component (34) forming part of the power conversion assembly,
   wherein:
the main unit (20) and the auxiliary unit (21, 22) are separate units configured to be connected by a unit fixation structure at an interface, and
the operative component (34) is suspended directly on the main unit (20).

2. The nacelle according to embodiment 1, wherein the main unit (20) houses the generator (33).

3. The nacelle according to embodiment 1 or 2, wherein the main unit (20) and the auxiliary unit (21, 22) are arranged side by side in a direction away from a rotational axis defined by the rotor-supporting assembly.

4. The nacelle according to any of the preceding embodiments, wherein the operative component (34) is suspended directly on a main frame (106) in the main unit (20).

5. The nacelle according to any of the preceding embodiments, wherein the operative component (34) is an electrolysis cell stack, a transformer, or a converter.

6. The nacelle according to any of the preceding embodiments, comprising a first supporting structure (78) for releasable suspension of the operative component (34) to the main unit (20) thereby facilitating the suspension of the operative component (34) directly on the main unit (20).

7. The nacelle according to any of the preceding embodiments, comprising a second supporting structure (78, 91) for releasable suspension of the operative component (34) to the auxiliary unit (21, 22).

8. The nacelle according to embodiments 6 and 7, wherein the first supporting structure and the second supporting structure is configured for simultaneous suspension of the operative component (34) both to the main unit (20) and to the auxiliary unit (21, 22).

9. The nacelle according to any of the preceding embodiments, comprising at least two auxiliary units (21, 22).

10. The nacelle according to embodiment 9, wherein two auxiliary units (21, 22) are arranged on opposite sides of the main unit (20).

11. The nacelle according to embodiment 10, wherein two auxiliary units (21, 22) are on opposite sides of a horizontal plane unit to form a lower and an upper auxiliary unit (21, 22).

12. The nacelle according to any of embodiments 11, wherein two auxiliary units (21, 22) are arranged above each other on one side of the main unit (20) and two auxiliary units (21, 22) are arranged above each other on an opposite side of the main unit (20) to form a lower and an upper auxiliary unit (61, 62) on opposite sides of the main unit (20).

13. The nacelle according to embodiment 12, wherein the main unit (20) comprises a third fixation structure for releasable fixation of the lower auxiliary unit (62) to the upper auxiliary unit (61).

14. The nacelle according to any of the preceding embodiments, wherein the operative component (34) comprises an electrical connector configured for electrical connection with the generator in the main unit (20), and wherein the electrical connector is connected via the interface between the main unit (20) and the auxiliary unit (21, 22).

15. The nacelle according to any of embodiments 5-14, wherein the main unit (20) defines an enclosed space housing the rotor-supporting assembly whereby the transformer and converter are physically separated from the main unit.

16. The nacelle according to any of the preceding embodiments, wherein the auxiliary unit (21, 22) is configured for isolation of the operative component (34) from the rotor-supporting assembly.

17. The nacelle according to any of the preceding embodiments, wherein the interface between the main unit (20) and the auxiliary unit (21, 22) defines a gap (167) allowing air to pass between a surface of the main unit (20) and a facing surface of the auxiliary unit (21, 22).

18. The nacelle according to any of the preceding embodiments, comprising a crane structure attached to the main unit and configured to hoist the auxiliary unit from ground to a position where the unit fixation structure can connect the auxiliary unit to the main unit.

19. The nacelle according to embodiment 18, wherein the crane structure is configured to hoist the auxiliary unit in a vertical direction without moving it in horizontal direction.

### LIST OF DRAWINGS

In the following, embodiments of the disclosure will be described in further details with reference to the drawing in which:

FIG. 1 illustrates a wind turbine;

FIG. 2 illustrates a nacelle of the wind turbine;

FIG. 3 illustrates a perspective view of the nacelle of FIG. 2;

FIG. 4 illustrates the nacelle from FIG. 3 but seen from above;

FIG. 5 illustrates an embodiment including left and right-side auxiliary units;

FIG. 6 illustrates schematically details of an assembly interface or main and auxiliary units;

FIG. 7 illustrates a main unit and auxiliary unit 6 after the auxiliary unit has been attached to the main unit;

FIG. 8 illustrates an embodiment including a first and second supporting structure;

FIGS. 9 and 10 illustrate further embodiments of a first and a second supporting structure;

FIGS. 11-14 illustrate 4 different embodiments of interfaces between a main unit and an auxiliary unit.

FIGS. 15 and 16 illustrate further details of a hook for attaching an auxiliary unit to a main unit;

FIGS. 17a-f show an exemplary installation method

FIGS. 18 and 19 show alternative views of a combined lift of a nacelle assembled from a main and an auxiliary unit.

### DESCRIPTION OF EMBODIMENTS

The detailed description and specific examples, while indicating embodiments, are given by way of illustration only, since various changes and modifications will become apparent to those skilled in the art from this detailed description.

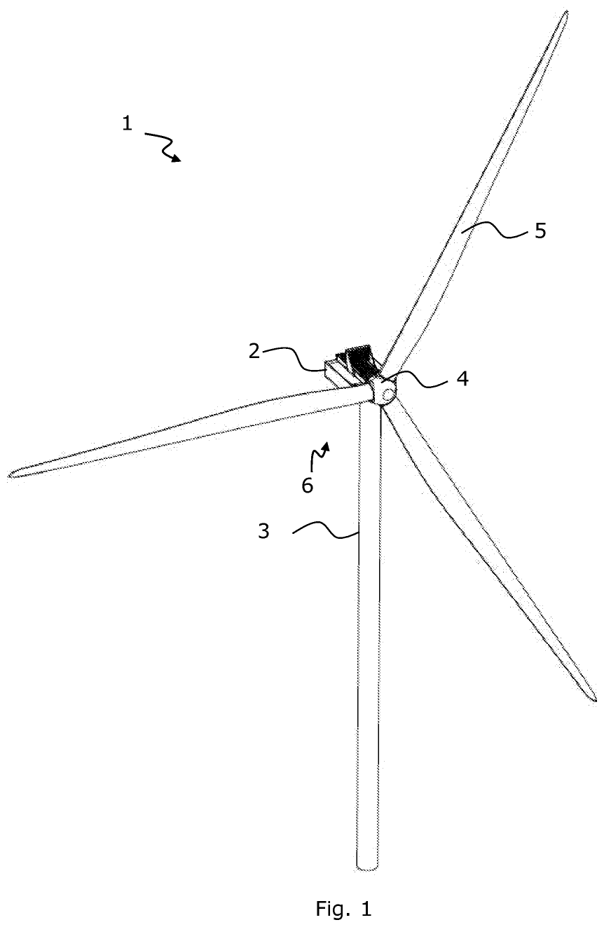

FIG. 1 illustrates a wind turbine 1 with a nacelle 2 mounted on a tower 3. A hub 4 carrying three rotor blades 5 forms a rotor 6 and is carried by a rotor-supporting assembly in the nacelle 2 commonly known as a drivetrain or powertrain. Typically, the rotor-supporting assembly comprises a rotor shaft connecting a gear arrangement and a generator to the hub. A gear is, however, not always required since the generator could be directly driven by the shaft.

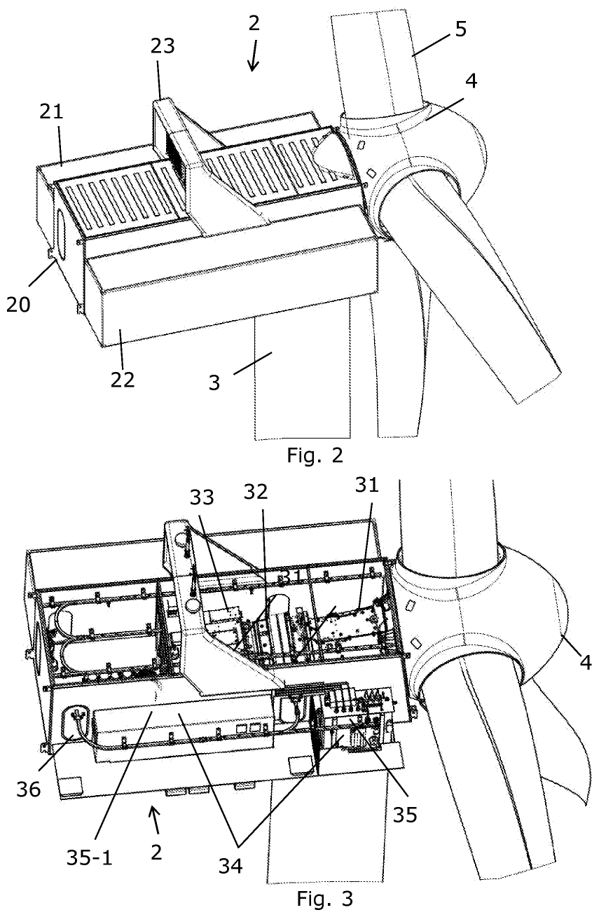

FIG. 2 illustrates a nacelle 2 comprising a main unit 20 and auxiliary units 21, 22. A cooler arrangement 23 is shown arranged on the nacelle 2, in particular, on top of the main unit 20. The cooler 23 may in particular include a heat exchanger which may serve to cool operational components in the main unit 20, and/or any of the auxiliary units 21, 22. The main unit 20 is shown mounted on the tower 3, possibly via a yawing arrangement (not shown), allowing the nacelle 2 to rotate in order to direct the rotor into the wind.

FIG. 3 illustrates a perspective view of a nacelle 2. In FIG. 3 the outer walls of the nacelle 2 are (for the sake of explanation) transparent, thereby revealing the interior parts of the nacelle 2 and the wind turbine components accommodated therein. The main unit 20 may accommodate a main bearing unit 31. The main bearing unit 31 may support a main shaft for rotation therein and other components such as e.g., a gear arrangement 32, a generator 33. These may e.g. be arranged sequentially behind the hub 4, along a direction defined by the rotational axis of the hub 4 or rotor 6. The components in the main unit 20 primarily form part of the drivetrain and/or powertrain. A main bearing unit 31 may in particular be supported on a main frame 106 of a main unit 20.

An auxiliary unit 22 accommodates an operative component 34 which may, by way of example, be in the form of a transformer unit 35, and/or a converter unit 35-1. One or more operative components 34 are illustrated accommodated in an auxiliary unit 22. The weight of an operative element 34 is in particular carried by the main unit 20. In embodiments, the weight of an operative element 34 may in particular be carried by a main frame 106 of the main unit 20. In alternative embodiments, the operative component 34 could be an electrolysis cell stack or a battery.

Each auxiliary unit 21, 22 may be mounted along a side of a main unit 20 by a unit fixation structure. In the disclosed embodiment, they are shown mounted in such a manner that one auxiliary unit 21 is mounted along a right side of the main unit 20 and the other auxiliary unit 22 is mounted along a left side of the main unit 20, as seen in a direction along a rotational axis of the hub 4 from the hub 4 towards a rear wall of the main unit 20.

A main unit 20 and an auxiliary unit 21, 22 may be enclosed and, optionally, sealable units such that one compartment is formed by an auxiliary unit 21, 22, defining an auxiliary space and another compartment is formed by a main unit 20, defining a main space. That allows the drivetrain to be isolated from operative components 34 such as a converter 35-1 or transformer 35. The two compartments may be joined by cooperating openings 36 allowing personnel and equipment to enter from the main space in the main unit 29 into the auxiliary space in an auxiliary unit 21, 22. The openings 36 may be sealed and thereby prevent fire etc. from spreading from one of the main 20 and auxiliary unit 21, 22 to the other one of the main 20 and auxiliary unit 21, 22.

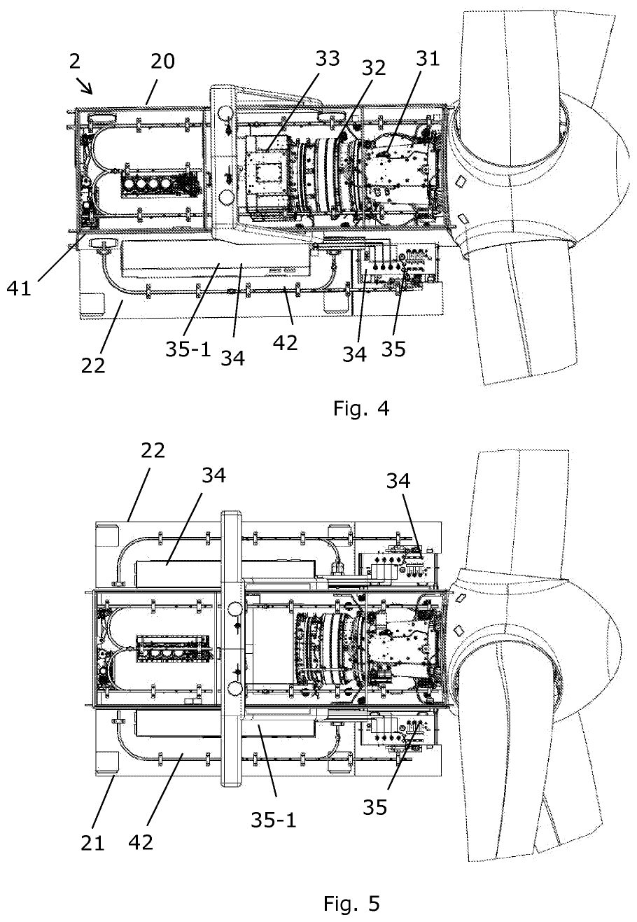

FIG. 4 illustrates an exemplary nacelle 2 seen from above and showing a single auxiliary unit 21 attached to a main unit 20.

FIG. 5 illustrates an embodiment showing two auxiliary units 21, 22 attached to a main unit 20. The left and right-side auxiliary units 21, 22 each contain at least one operative component 34. These may be substantially identical operative components 34, thereby establishing a weight balance. The provision of two similar operative components 34, e.g. such as two switchgear sets 35-1 and/or two transformers 35, gives the wind turbine two similarly functioning operative components 34, one contained in each of the auxiliary units thereby doubling the capacity of a single operative component 34. The operative components 34 may be identical in nature and specification. In case of component failure of one unit, the wind turbine may continue operation on reduced power while an operative component 34 in another auxiliary unit 21, 22 may be replaced.

FIGS. 4 and 5 also illustrate a nacelle internal transport system 42 which may optionally be provided. A transport system may comprise a rail. A rail may extend from a main unit 20 into an auxiliary unit 21, 22. When a movable lifting device such as a winch is associated with the rail, i.e. slidably suspended thereon, this may thereby allow easy handling of spare parts etc. inside the wind turbine nacelle 2.

As shown according to FIGS. 2-5, the auxiliary units 21, 22 may be constituted by elements having generally the shape and size of standardised freight containers such as a 40 foot shipping freight containers having a dimension and structural specifications as provided by the ISO standard, ISO 668:2013 for series 1 freight containers. The auxiliary units 21, 22 may be attached to a main unit 20 by its ISO-corner lifting structure, typically moulded in steel and constituting a particularly strong interface to the container.

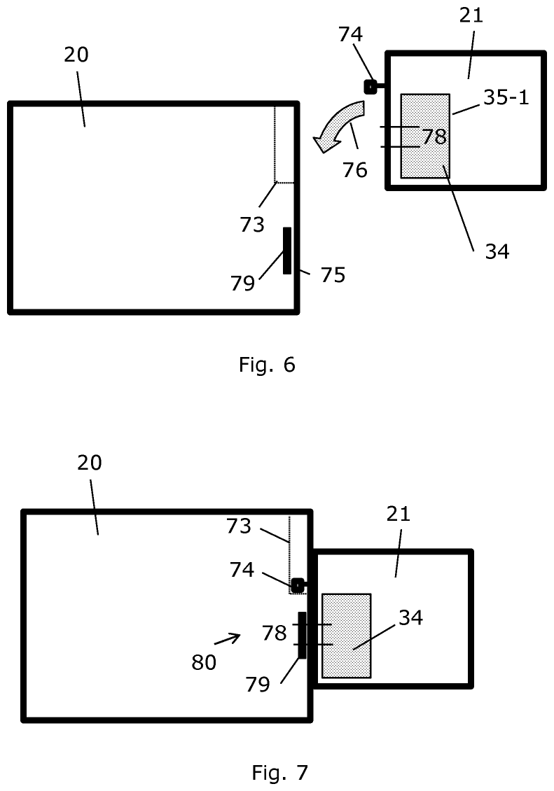

FIG. 6 illustrates schematically details of an interface between a main unit 20 and an auxiliary unit 21, 22. An interface joins an auxiliary unit 21 and the main unit 20 in a releasable manner and allows the auxiliary unit 21 to be attached to the main unit 20 after transport to the installation site, or to be replaced e.g. during maintenance. An auxiliary unit 21 may be attached to the main unit 20 independently of any other units. The unit fixation structure may be constituted by recess 73 such as an inward groove or a track in the main unit 20. A recess 73 is illustrated with a dotted line shown in the form of a groove in an outer surface 75 of a main unit 20. The recess 73 may have a C-shaped profile in a horizontal cross section, i.e. when seen from above, the recess may be configured to receive a projection 74 provided on the auxiliary unit 21, 22. A recess 73 may receive a projection 74 through a procedure where an auxiliary unit 21 is lowered down along an outer surface 75 of the main unit 20. This is illustrated by the arrow 76 in FIG. 6. This procedure allows easy replacement of an auxiliary unit 21 and the operative component 34 accommodated therein without detachment of another auxiliary unit 22 and any operative component 34 accommodated therein.

The main unit 20 may form part of a load path from an operative component 34, is housed in an auxiliary unit 21, 22, down into the tower 3, e.g. via a main frame 106 of the main unit 20. Particularly, this load path may be slightly different from a load path from an auxiliary unit 21, 22 into the tower 3. In the following, this is explained relative to different embodiments.

The auxiliary unit 21 can, for example, accommodate an operative component 34 such as a converter 35-1 which may be fixed to the auxiliary unit 21, 22 by the a second supporting structure 80, which, by way of example, may be constituted by one or more support legs 91, which may be supported on the floor or bottom frame of an auxiliary unit 21.

The main unit 20 may have a strengthening bracket 79 attached to its outer wall 75. This strengthening bracket 79 may be configured for receiving the weight of an operative component 34 such as a converter 35-1 when an auxiliary unit 21, 22 is received and fixed on the main unit 20. The strengthening bracket 79 may itself be operatively supported on the main unit 20, e.g. the strengthening bracket 79 may be operatively supported on a main frame 106 of the main unit 20.

FIG. 7 illustrates a main unit 20 and an auxiliary unit 21 after an auxiliary unit 21 has been attached to a main unit 20. In this state, an interface element 78 on the operative component side of the first supporting structure 80 may extend sideways and thereby engage into the main unit 20, e.g. by engaging with a strengthening bracket feature 79 of the main unit 20. The bracket 79 may be connected to a rigid frame in the main unit 20, e.g. it may be supported by the main frame 106 of the main unit. In this way, loads from the operative component 34 may be directed into the tower 3 via a main frame 106.

The means of support of an operative component 34 on the main unit 20 constitutes a first supporting structure 80, e.g. by which an operative component 34 such as a converter 35-1 or transformer 35 is carried directly by the main unit 20. The first supporting structure 80 forms part of a load path from the operative component 34 into the tower 3. The illustrated interface between a main unit 20 and an auxiliary unit 21, 22 (see e.g. FIGS. 6-8) forms part of another load path from an auxiliary unit 21, 22 into the tower 3.

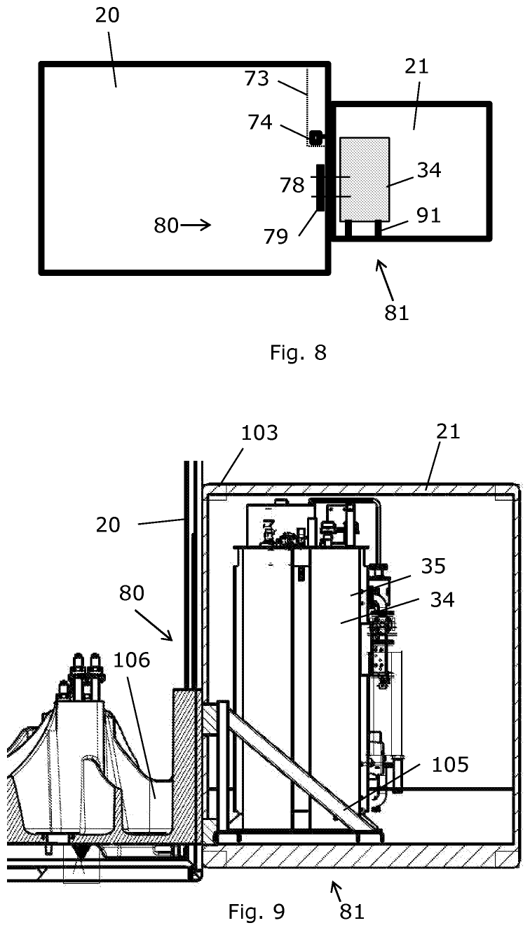

FIG. 8 illustrates an embodiment where the first supporting structure 80 is constituted by a suspension interface 78. A second supporting structure 81 may be constituted by support legs 91 between a bottom of the operative component 34 and the bottom of the auxiliary unit 21, 22.

FIG. 9 illustrates in further details another embodiment of the first and second supporting structures 80, 81. In this embodiment, a main unit 20 and an auxiliary unit 21 are joined by a unit fixation structure constituted by corner lifting points 103 of the container which constitutes the auxiliary unit 21.

A transformer 35 may be carried by the first supporting structure 80, here in the form of a support frame 105 resting on the bottom of an auxiliary unit 21. It may be suspended directly on a main frame 106 of the main unit 20, inside the main unit 20. The main frame 106 thereby forms part of the load path between the operative component 34 and the tower 3.

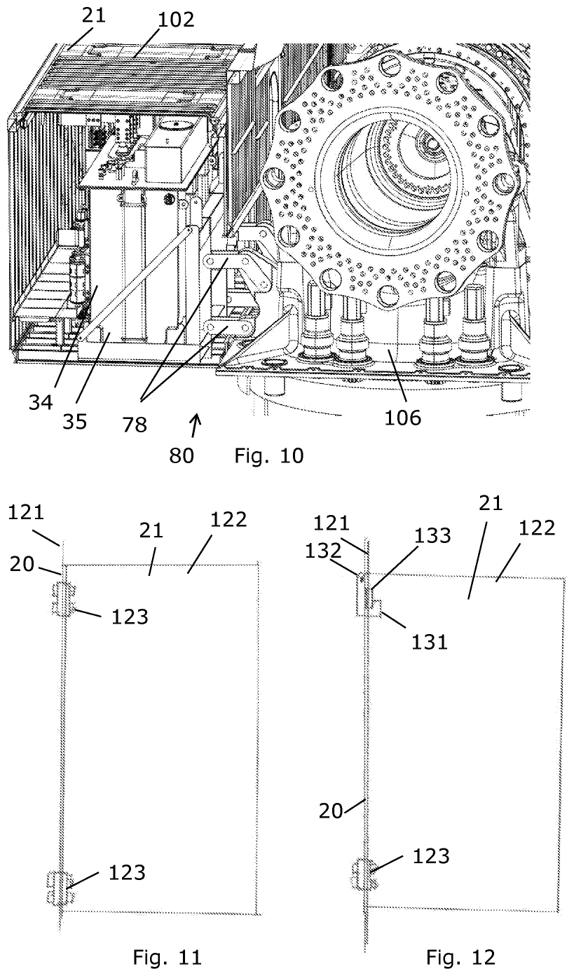

FIG. 10 shows an alternative view including an embodiment comparable to the embodiment in FIG. 9. Here, the first supporting structure 80 may include an interface structure 78 associated with one side of an operative component 34, being an attachment side thereof. The interface structure 78, for suspending the operative component 34 at a main frame 106 of a main unit 20, may comprise a bracket structure comprising lower brackets and upper brackets as illustrated. The interface structure 78 forms part of the first supporting structure 80 which is connected with the main frame 106 inside a main unit 20. The main frame 106 thereby forms part of a load path when into the tower 3, when an operative component 34 is connected to the main unit 20.

FIGS. 11-14 illustrate four different embodiments of the unit fixation structure forming the interfaces between the main unit 20 and an auxiliary unit 21, 22. In each of these four illustrations, the main unit 20 and the auxiliary unit 21 are connected by cooperating structures forming the unit fixation structure and being described in further details below.

In FIG. 11, the cooperating structures are shown by way of example constituted by brackets 123 by which the main 20 and auxiliary units 21 are joined by bolts.

In FIG. 12, the cooperating structures are constituted by way of example by a lower bracket 123 like the one used in the embodiment per FIG. 11. At an upper edge, the main unit 20 and auxiliary unit 21 may be assembled by a hook 131 pivotally joined to the main unit 20 at a hinge point 132. The hook 131 can rotate as indicated by the arrow 133 and thereby engage the edge-bracket 134 of an auxiliary unit 21 when alongside and adjacent the main unit 20, as illustrated. When a lower bracket 123 connecting the lower region of a main 20 and auxiliary 21 unit is removed, and the hook 131 is rotated into the main unit 20, the auxiliary unit 21 can be lowered to the ground.

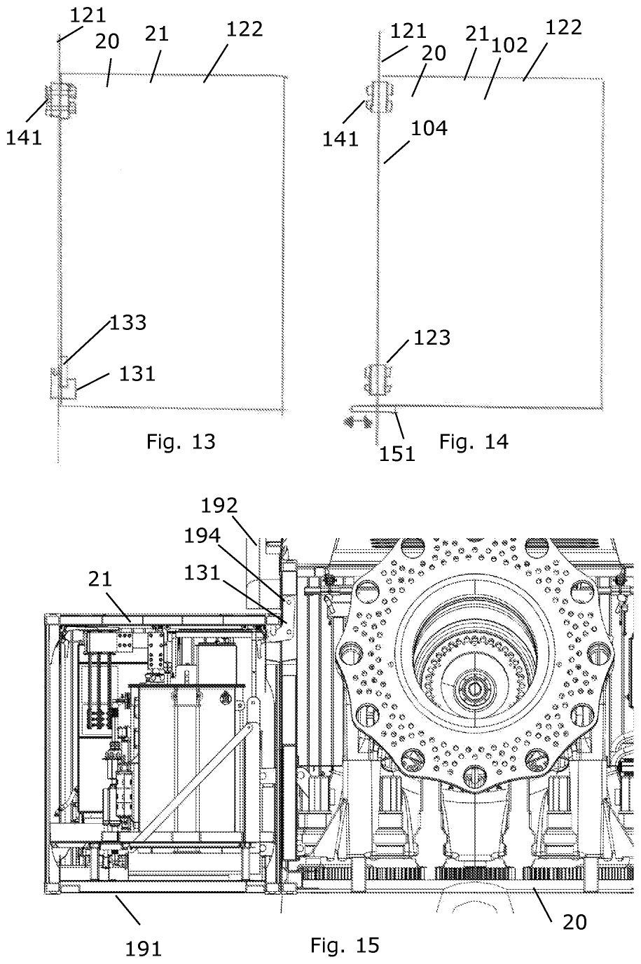

In an embodiment shown in FIG. 13 the lower bracket 123 may be replaced by an upper bracket 141, and the hook 131 may be placed at a lower edge of the main unit 20, reaching to a lower edge of an auxiliary unit 21.

In any of the embodiments shown in FIGS. 11-14, the brackets or hooks which connect the auxiliary unit 21, 22 to a main unit 20 may direct the load from the auxiliary unit 21, 22 into a rigid part of the main unit 20, e.g. into load carrying column e.g. a corner column of the main unit. Various structural features may connect the brackets or hooks which carry the auxiliary unit 21 directly to the main frame 106 in the main unit 20 to thereby establish a load path into the tower 3.

In addition to the hook and bracket unit fixation structure illustrated in FIGS. 11-14, a first supporting structure 80 preferably connects an operative component 34 directly to the main frame 106 inside the main unit 20.

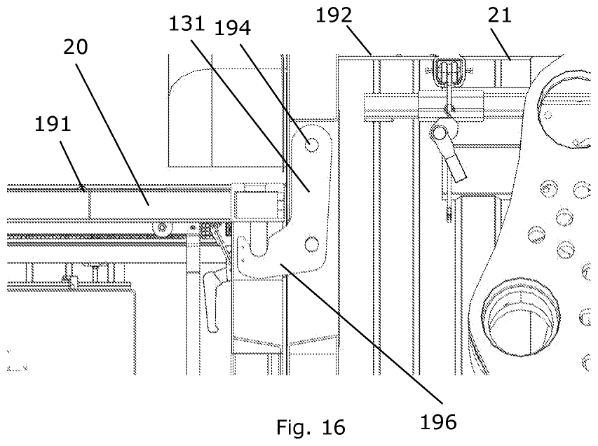

FIGS. 15 to 16 illustrate further details of a unit fixation structure in the form of a hook 131 for attaching an auxiliary unit 21, 22 to a main unit 20. The hook 131 may be suspended rotationally at a hinge 194 in the main unit 20. The hook 131 can rotate through an opening 73 in the auxiliary unit 20 and catch a recess or edge 196 in the auxiliary unit 21.

The hook could also be attached in the auxiliary unit and catch a recess or edge in the main unit, in which case it may be attached reversely. The position of the hook may be controlled by an actuator.

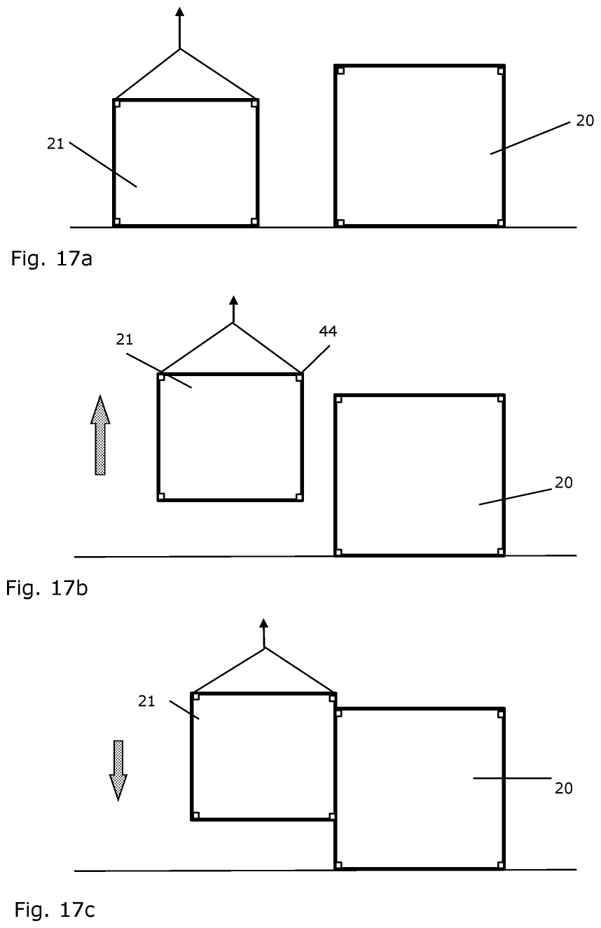

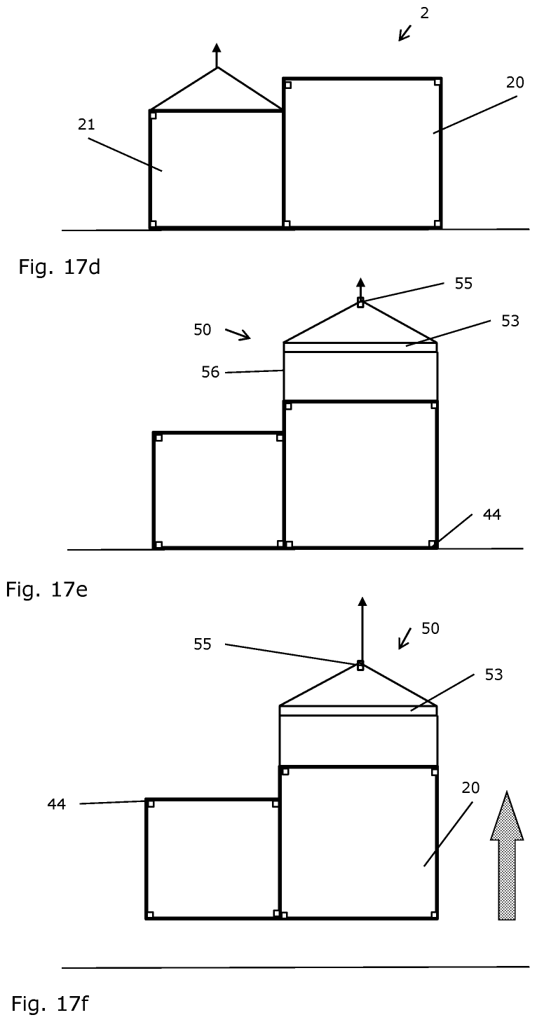

FIGS. 17a-f show an exemplary installation method. A main unit 20 and an auxiliary unit 21 are brought to an erection site. They may be placed on the ground (FIG. 17a). Thereafter (FIG. 17b) the auxiliary unit 21 may be lifted up and moved towards the main unit 20. The auxiliary unit 21 can then brought in a controlled way adjacent the main unit 20 and attached to it as it is lowered in position (FIG. 17c). In its assembled configuration, creating a nacelle 2, the auxiliary unit 21 is connected to the main unit 20 (FIG. 17d). Internally, the operational component 34 in the auxiliary unit 21 can be brought from a position of support at a second supporting structure 81 in the auxiliary unit 21, to a position of support at a second supporting structure 80 in the main unit 20. The method may include transferring load from the second supporting structure 81 to the first supporting structure 80 while moving the auxiliary unit 21 towards an assembly position wherein the unit fixation structure connects the auxiliary unit 21 to the main unit 20. With the auxiliary unit 21 supported on the main unit 20, and with an operational component 34 in the auxiliary unit 21 also supported on the main unit, preferably at a second supporting structure 80, a lifting yoke 50, suspended from a crane, can be attached to the main unit 20 (FIG. 17e). The lifting yoke (50) can have a variety of configurations. In one example, connecting elements 56 suspended from the yoke 50 may be attached to lifting points of the nacelle 2. These may be in the form of lifting castings 44 or other brackets. With a lifting yoke 50 attached, the main unit 20 may be hoisted together with the auxiliary unit 21, 22 as shown for example in FIG. 17f in which the nacelle 2 is lifted off the ground. The auxiliary unit 21 is supported and lifted by the main unit 20 during the hoisting. In particular, the main nit 20 forms a primary support for the auxiliary unit 21, which is cantilevered on the main unit 20. Once lifter to a vertical height above the tower 3 the nacelle 2 can be installed thereon. This may me achieved in particular by securing a main frame 106 in the main unit 20 to the tower top 3, especially at a yawing arrangement thereof. With the main unit 20 installed on the tower top, the auxiliary unit and its internal components are thereby supported in their operative position on the main unit 20. The lifting yoke 50 can then be removed from the main unit 20, thereby leaving the nacelle 2 installed on the tower 3. A rotor 6 including blades 5 and a hub 4 can then be installed on the nacelle 2 (see e.g. FIG. 2, 3, 4 or 5). Advantageously, this method of lifting is very efficient and can lead to a more secure lift than in a case where both the main unit 20 and an auxiliary unit 21 would be connected to the yoke 50. Although the auxiliary unit 21 is not itself connected to the lifting yoke 50 nor the main hoisting crane, the lift by this method is secure because it relies in particular on the auxiliary unit 21 being supported on the main unit 20 in the same way as it is supported during operation of the wind turbine. This method also embodies additional efficiencies because it is easier to assemble the main unit 20 and auxiliary unit 21 on the ground to do so at a tower top after e.g. installation of the main unit alone, first. This objective is achieved all the more by assembly the operational element 34 with the main unit 20 while on the ground.

The lifting yoke 50 may be attached to the main unit 20 via lifting castings 44 at the main unit 20 which lifting castings 44 are positioned at said main unit 20. For example, lifting castings 44 may be provided at lower side edges of the main unit 20. Thereafter the main unit 20 may be hoisted together with the auxiliary unit 21, 22 by means of a crane attached to the lifting yoke 50, wherein the main unit 20 is suspended during said lift from said lower lifting castings 44 at said main unit 20. Alternatively, the lifting yoke 50 may be attached to the main unit 20 via lifting castings 44 at the main unit 20 which lifting castings 44 are positioned at said main unit 20 at upper side edges thereof. Thereafter main unit 20 may be hoisted together with the auxiliary unit 21 by means of a crane attached to the lifting yoke 50, wherein the main unit 20 is suspended during said lift from said upper lifting castings 44 at said main unit 20. For improved stability during lifting, a main unit 20 may comprise reinforcement beams which define a load path between said lifting castings 44 and said main frame 106 of said main unit 20.

The main unit 20 may comprise ISO type corner castings 45 at corners thereof and wherein one or more of the lifting castings 44 is an intermediate lifting casting 46 additional to said ISO type corner castings 45. In particular, lifting points of the nacelle 2 may include lifting castings 44 located at different positions on the main unit 20. For example, either or both the main unit 20 and the auxiliary unit 21 may be configured as an ISO type container with lifting castings 44 in the form of corner castings 45 at top and bottom corners of the main unit 20 and/or auxiliary unit 21. Alternatively or additionally, the main unit 20 may be provided with additional lifting castings 44 in the form of intermediate lifting castings 46. These may in particular be provided at one or both top side edges of a main unit 20. Intermediate lifting castings 46 may in particular be provided at locations on a main unit 20 between the corner castings 45 of a main unit 20.

A lifting yoke 50 may be attached to the main unit 20 via lifting fittings at the main unit 20 which lifting fittings are provided at said main frame 106 of said main unit 20. Thereafter the main unit 20 may be hoisted together with the auxiliary unit 21 e.g. by means of a crane attached to the lifting yoke 50, wherein the main unit 20 is suspended during said lift from said lifting fittings at said main frame 106. This arrangement may reduce the need for reinforcement beams around the main unit. For example there may thereby be no need for additional reinforcements between lifting castings 44 and the main frame 106 by following this method step.

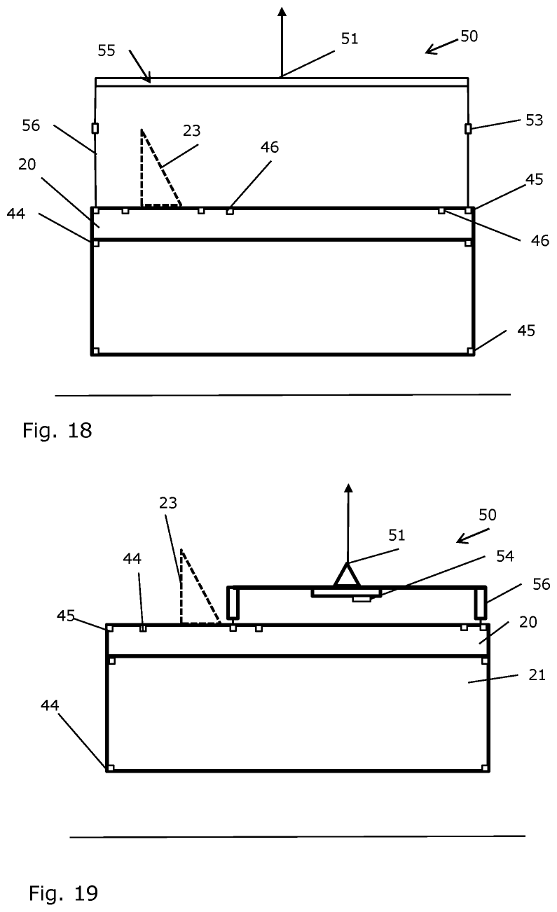

A lifting yoke, e.g. as illustrated in FIGS. 17a-f and FIG. 18 may be a beam-type yoke having a main beam 55 and one or more transverse beams 53. Lifting connectors 56 may descend from one or more transverse beams 53 to lifting points at the top or bottom of a main unit 20. A lifting connector 56 may in particular be suspended from the free end of a transverse beam 53. A crane attachment point 51 may be provided at said main beam 55. The method may include a step of connecting one or more lifting connectors 56 to lifting points at said main unit 20. Once the yoke 50 is connected to lifting points in the main unit 20, the main beam 55 of the yoke 50 is preferably aligned with the main axis of the wind turbine's drivetrain.

An alternative type of yoke 50 is shown in FIG. 19. In particular, a yoke 50 may include balance adjustment arrangements such as for example a position-adjustable crane attachment point 51 in relation to the yoke 50. The crane attachment point 51 may be shifted, e.g. by a hydraulic or electric drive or other, in a direction in line with the main beam 55 or transverse to the main beam 55. Thereby, the crane attachment point 51 can be brought into closer vertical alignment with the centre of gravity of a nacelle 2, assembled from a main unit 20 and one or more auxiliary units 21, 22. This can ensure that during a lift, the assembled main-and auxiliary units are kept level. Also shown in FIG. 19 is an additional arrangement at a yoke 50 for making small adjustments to the weight distribution of the assembled nacelle 2. In particular, a displaceable ballast element 54 at the yoke 50 may be provided in connection with a drive to ensure the nacelle 2 is kept level during a lift. In particular, a displaceable ballast 54 may be displaceable in a direction along the axis of a main liftin beam 55. Alternatively or additionally, a displaceable ballast 54 may be displaceable in a lateral direction relative to the yoke 50, i.e. in a direction parallel to one or more transverse beams 53.

Advantageously, a cooler arrangement 23, configured to cool power generation or power management equipment in the nacelle 2, may be fixed to the nacelle 2 prior to a lift of the assembly. In particular a cooler arrangement 23 may be placed atop the main unit 20 prior to hoisting an assembled main unit 20 and auxiliary unit 21. In connection with this, a lifting yoke 50 may connect with one or more lifting castings 44 which lifting castings 44 may be intermediate lifting castings 44. In particular, the yoke 50, when a cooler arrangement 23 is fixed to the nacelle 2, may be connected to the main unit 20 entirely at lifting points on the main unit 20 which are all on a same end of the main unit 20 in relation to the cooler arrangement 23. This method step also can reduce the work needed atop the tower 3 after installation of a nacelle 2. i.e. by pre-attaching the cooler arrangement 23 prior to attachment of a lifting yoke 50 to a main unit 20, a further efficiency may be achieved in the hoisting stage and for the installation overall.

### DEFINITIONS

Herein, the term “nacelle” means the generally accepted term describing the machine house for a wind turbine, i.e. that part which carries the rotor and drivetrain, and which is carried by the wind turbine tower.

The terms “main unit” and “auxiliary unit” herein refers to units which can be transported separately, and which can be assembled with one or more other units to form the nacelle.

Herein, the term “rotor-supporting assembly” refers to those parts of the nacelle which carries the rotor, typically a drivetrain, a main bearing and a main frame. The drivetrain may include different components depending on the type of wind turbine, e.g. a rotor shaft, the generator, and optionally a gearbox between the rotor shaft and the generator. The term “supporting structure” (e.g. first supporting structure or second supporting structure) may in particular designate a cantilever arrangement. It does not specifically or exclusively define an arrangement in which the supported element is suspended below the supporting element.

1. A wind turbine installation method for a horizontal axis wind turbine comprising a tower, a nacelle atop the tower and a powertrain housed in the nacelle, a rotor configured to drive the powertrain, and the nacelle further including a main frame which forms part of a load path between the rotor and the tower; the installation method including:
providing a nacelle at a wind turbine erection site, said nacelle comprising:
a main unit, arranged to be connected to the wind turbine tower and configured for housing a rotor-supporting assembly of the wind-turbine;
at least one auxiliary unit housing an operative component forming part of the power conversion assembly, wherein:
the main unit and the auxiliary unit are separate units configured to be connected by a unit fixation structure at an interface, and wherein the operative component is supportable directly on the main unit, said method further including:
receiving a said main unit to a site of erection of the wind turbine,
receiving a said auxiliary unit to said site of erection of the wind turbine,
receiving a said operative component to said site of erection of the wind turbine,
attaching to said main unit the said auxiliary unit and said operative component, and
attaching a lifting yoke to the main unit and hoisting the main unit together with the auxiliary unit, by means of a crane attached to the lifting yoke, wherein the auxiliary unit, is supported and lifted by the main unit during the hoisting, and
installing the main unit and the attached auxiliary unit, at the tower top, and
releasing the lifting yoke from the main unit.

2. The method according to claim 1, wherein the operative component is attached directly to the main unit while it is contained in the auxiliary unit.

3. The method according to claim 1, wherein the operative component is first supported by the auxiliary unit, via a second supporting structure and subsequently by the main frame via a first supporting structure.

4. The method according to claim 3, comprising transferring load from the second supporting structure to the first supporting structure while moving the auxiliary unit, towards an assembly position wherein the unit fixation structure connects the auxiliary unit, to the main unit.

5. The method according to claim 1, including attaching the lifting yoke to the main unit via lifting castings at the main unit which lifting castings are positioned at said main unit at lower side edges thereof and thereafter hoisting the main unit together with the auxiliary unit, by means of a crane attached to the lifting yoke, wherein the main unit is suspended during said lift from said lower lifting castings at said main unit.

6. The method according to claim 1, including attaching the lifting yoke to the main unit via lifting castings at the main unit which lifting castings are positioned at said main unit at upper side edges thereof, and thereafter hoisting the main unit together with the auxiliary unit, by means of a crane attached to the lifting yoke, wherein the main unit is suspended during said lift from said upper lifting castings at said main unit.

7. The method according to claim 6, wherein said main unit comprises reinforcement beams which define a load path between said lifting castings and said main frame of said main unit.

8. The method according to claim 5, wherein said main unit comprises ISO type corner castings at corners thereof and wherein one or more of said lifting castings is an intermediate lifting casting additional to said ISO type corner castings.

9. The method according to claim 1, including attaching the lifting yoke to the main unit via lifting fittings at the main unit which lifting fittings are provided at said main frame of said main unit and thereafter hoisting the main unit together with the auxiliary unit, by means of a crane attached to the lifting yoke, wherein the main unit is suspended during said lift from said lifting fittings at said main frame.

10. The method according to claim 1, wherein said lifting yoke comprises a beam-type yoke having a main beam and one or more transverse beams and wherein a crane attachment point is provided at said main beam and wherein lifting connectors for attachment to said main unit are suspended from said transverse beams, said method including the step of connecting said lifting connectors to lifting points at said main unit wherein said main beam of said beam-type yoke is aligned with the main axis of the wind turbine's drivetrain.

11. The method according to claim 10, said method further including a step of providing a cooler arrangement configured to cool power generation or power management equipment in the nacelle, and fixing said cooler arrangement atop the main unit prior to hoisting the main unit and auxiliary unit.

12. The method according to claim 11, said method further including fixing said cooler arrangement atop the main unit prior to attaching said lifting yoke to said main unit.

13. The method according to claim 10 including adjusting the position of said crane attachment point in relation to said yoke thereby to adjust the crane attachment point closer into vertical alignment with the centre of gravity of the combined assembly of said main unit and auxiliary unit.

14. The method according to claim 10 including adjusting the position of the centre of gravity of the combined assembly of said main unit and auxiliary unit, by adjusting the position on said yoke of a displaceable ballast element of said yoke.
